(19) United States
(12) Patent Application Publication
(10) Pub. No.: US 2008/0315476 A1
(43) Pub. Date: Dec. 25, 2008

(54) Combinable positioning table

(76) Inventor: Majid Akhavan-Malayeri, N Potomac, MD (US)

Correspondence Address: MAJID AKHAVAN-MALAYERI, 15209 WINESAP ROAD, POTOMAC, MD, 20878, US

(21) Appl. No.: 11/812,908

(22) Filed: Jun. 22, 2007

(51) Int. Cl. B23Q 3/00

(52) U.S. Cl. 269/20; 269/58; 269/71

(57) ABSTRACT

A combinable positioning table constructed from an assembly and a cradle. The assembly comprises means for rotating the cradle which includes attachable elements that can be rotated about first axis and capable of being attached to the sides of the cradle for rotating the cradle, wherein the cradle includes means for attaching to the attachable elements of the assembly and where in said cradle has a work holder and means for rotating the work holder in an axis of rotation perpendicular to the first axis of rotation and wherein said cradle can be separated from the assembly so that the separated assembly and separated cradle can operate as independent positioning tables.

### FIELD OF INVENTION

This invention relates to positioning tables for a work piece so that a work piece can be rotated in a first axis and in a second axis perpendicular to the first axis. The invention provides for one positioning table which allows the rotation of a work piece about a first axis and second axis and can be separated into two positioning tables that can be used independently of each other with limited modification.

The prior art has provided three separate positioning tables. The first positioning table provides means for rotating a work piece about an axis commonly referred to as the 4^{th} axis. A second positioning table provides means for rotating the work piece about an axis perpendicular to the axis of rotation of the work piece in the first positioning table. This axis of rotation is commonly known as the 5^{th} axis of rotation. The third positioning table is a combination table provides means for rotating the work piece about both axis as set forth in the first and second positioning table, i.e. a combination of 4^{th} and 5^{th} axes. The combination table of 4^{th} and 5^{th} axes in the prior art is not separable so that the 4^{th} axis or the 5^{th} Axis can not be used independently.

These three separate positioning table have been used with CNC (Computer Numeric Controlled) machines. Typically a CNC machine is equipped with a positioning table which holds a work piece in place and allows the work piece to be moved precisely in the direction of three perpendicular axes labeled “X” or the “1^{st} Axis” (moving the piece laterally left and right), “Y” or the “2^{nd} Axis” (moving the piece back and forth) and “Z” or the “3^{rd} Axis” (moving the piece up and down). The prior art three positioning tables provide the CNC machine with two additional axes for manipulating and positioning of the work piece. The additional axes can be achieved by placing one of the three positioning tables in the CNC machine thereby providing achieving rotation of the work piece in the 4^{th} or 5^{th} axis.

The prior art positioning tables have numerous disadvantages. The primary disadvantage of the prior art positioning tables is that the table that allows the combined rotation of the 4^{th} Axis and 5^{th} axis suffer from significant limitations regarding the shape and the size (e.g., long, wide, tall) of the work pieces that can be used. This is especially critical when they are used with CNC machined where space is limited and orientation is important. Therefore, to have complete flexibility regarding the size and shape of work pieces, one has to invest in 3 separate positioning tables (one for the 4^{th} Axis only to support larger work pieces, one for the 5^{th} Axis only to support large work pieces, and one for the combined 4^{th} and 5^{th} axes when the work piece is relatively small). This invention eliminates the need for three separate positioning tables by offering a single positioning table supporting both the 4^{th} and 5^{th} axes where the two axes can be detached from each other and operated on a stand-alone basis.

Another disadvantage of the prior art is that the use of multiple positioning tables for a single work piece may result in loss of precision as the work piece may have to be set up on more than one positioning table, which introduces loss of precision as parts are transferred from one positioning table to another.

Another disadvantage of the prior art is that the use of multiple positioning tables for a single work piece may result in increased set up time and loss of efficiency (man hours).

Another disadvantage of the positioning tables of the prior art is the use of gears or gearboxes external to the motor housing, or other types of rotational power source, for rotation of the work piece. These gears or gearboxes reduce the precision in positioning of the work piece, especially as said gears or gearboxes wear out over time and due to normal operation and cause looseness, and therefore imprecision.

An objective of this invention is to provide a configurable positioning table that can be rotated around both the 4^{th} Axis and the 5^{th} Axis simultaneously and is capable of being disassembled to provide positioning tables used to rotate and position the work piece around the 4^{th} Axis, or around the 5^{th} Axis, independently.

### BRIEF DESCRIPTION OF THE DRAWINGS

FIG. 1 shows a positioning table that can rotate a work piece in the fourth or fifth axis.

FIG. 2 shows a positioning table that can be used for long work pieces

FIG. 3 shows a positioning table that can be used for 3 sided operations.

FIG. 4 shows a positioning table that can be used for big round work pieces.

### SUMMARY OF THE INVENTION

A combinable positioning table constructed from an assembly and a cradle. The assembly comprises means for rotating the cradle which includes attachable elements that can be rotated about first axis and capable of being attached to the sides of the cradle for rotating the cradle, wherein the cradle includes means for attaching to the attachable elements of the assembly and where in said cradle has a work holder and means for rotating the work holder in an axis of rotation perpendicular to the first axis of rotation and wherein said cradle can be separated from the assembly so that the separated assembly and separated cradle can operate as independent positioning tables.

### DETAILED DESCRIPTION OF THE INVENTION

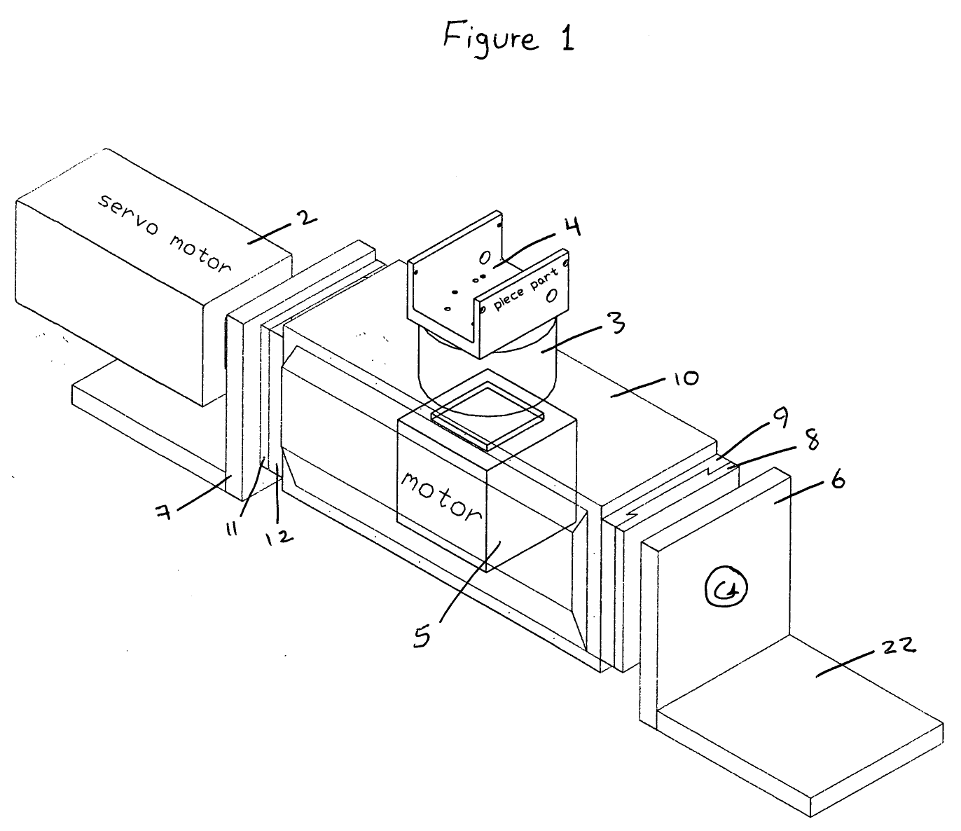

FIG. 1 shows a positioning table having means for the rotating the work piece about both axes as set forth in the first and second positioning table. The positioning table has an assembly that includes servo motor 2 in a housing 7 for rotating the cradle 10 and rotating attachable elements 11 and 8 about a first axis and end piece 22 for supporting rotating element 8. Cradle 10 comprises a motor 5, which can rotate a work piece holder 3 about a second axis that is about perpendicular to the first axis. Cradle 10 has means 9 and 12 for attaching the cradle 10 to rotating attachable elements 11 and 8 of the assembly. The particular means shown is a sliding dovetail that allows elements 8 and 11 to attach to elements 9 and 12. Other means such as conventional fasteners can be used to attach the cradle to the rotating elements 11 and 8. This positioning table allows a work piece 4 in holder 3 to be rotated about its axis and at the same time the work piece can be rotated about the axis of motor 5. This allows the work piece to be positioned to accommodate various types of cuts without the need to remove the work piece from the work holder. The assembly and the cradle usually require end pieces 22 and 23 as shown in the drawings to operate independently.

The motors can be programmed with conventional technology to rotate the work piece in configurable pattern so other tools such as cutters and drills can operate on the work piece. One type of motor used in the cradle was TPM A/C servo made by Alpha GmbH a part of Wittgenstein AG in Germany. Other motor types matching the desired dimensions and matching the desired precision can be used.

A cradle 10 usually includes a housing that has a motor that can rotate a work holder and has means for attaching to an assembly that rotates the cradle to form a positioning table so that he axis of rotation of the work piece by the motor associated with the cradle is perpendicular to the axis of rotation of the cradle when rotated by the assembly. In the preferred embodiment the motor is located within the housing of the cradle. This provides greater manipulation of the cradle without being restricted by a motor that is located outside of the housing. Other power sources such as hydraulic or pneumatic can be used.

The cradle and assembly are designed so they can be easily separated and that the separated assembly and separated cradle can operate as an independent positioning table.

These independent positioning tables do not require any substantial modification to operation to as a separate positioning table.

The work piece can be used in conjunction with a 3-axis CNC machine. The rotary table can be placed inside a CNC machine without taking the part of the work holder to perform different operations on the work piece. The modular design allows for greater flexibility in manipulating the work piece so more operations can be performed on the work piece with out removing the work piece from the work holder.

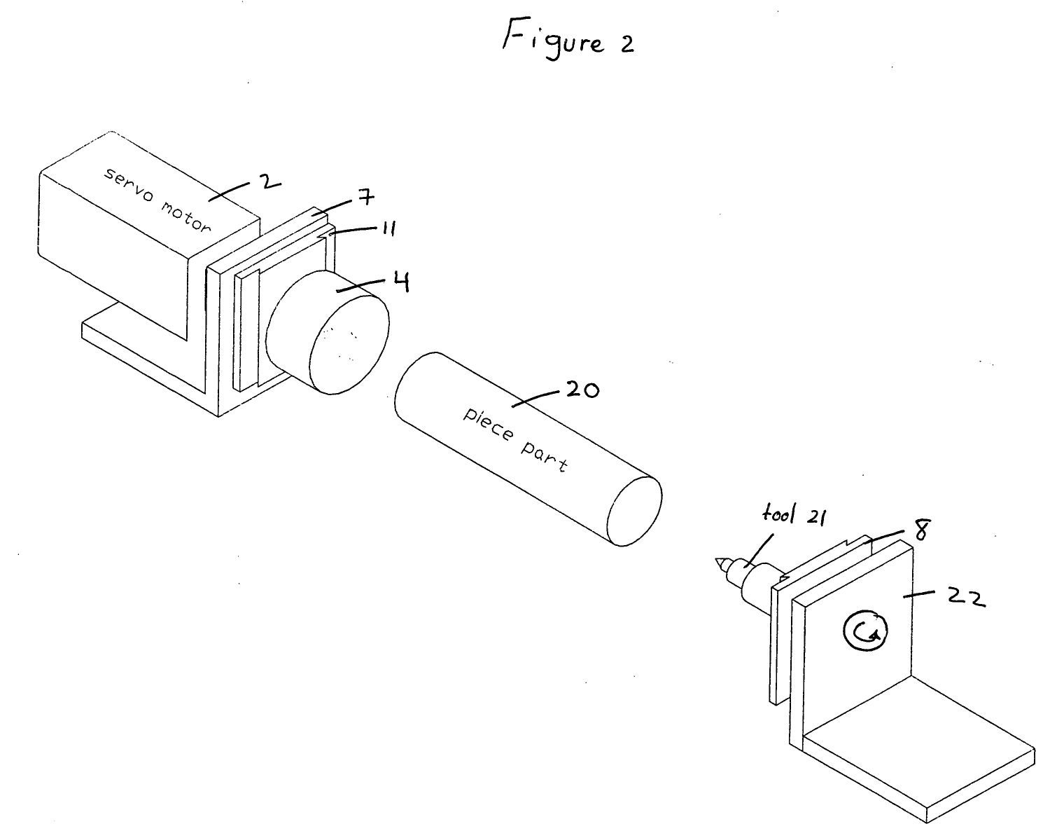

FIG. 2 shows the cradle 10 being removed from the assembly. A work holder 4 is attached to 11. Work piece 20 is attached to rotating holder 4 and a tool 21 is attached to end piece 22 so that the tool 21 can operate on rotating work piece 20. The end piece 22 holds tool 21 in a fixed position. In this subassembly with the cradle removed, the positioning table functions as the prior art first positioning table.

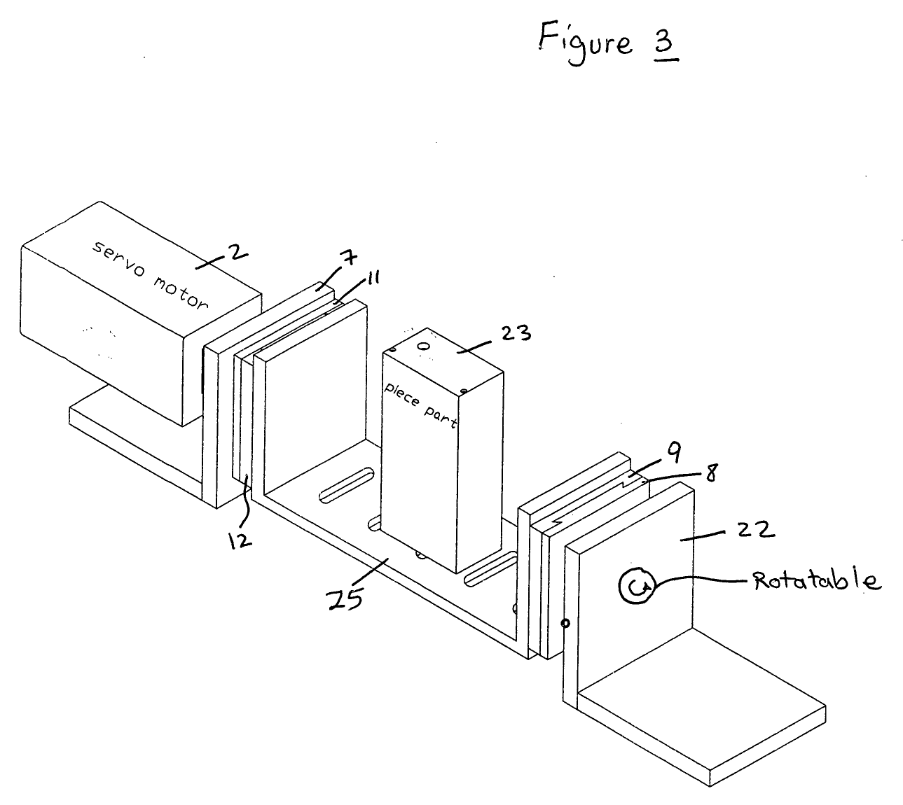

FIG. 3 shows an alternative way of positioning work piece 23 by using rotating holder 25. Holder 25 attaches to rotating element 11 and rotating member 8.

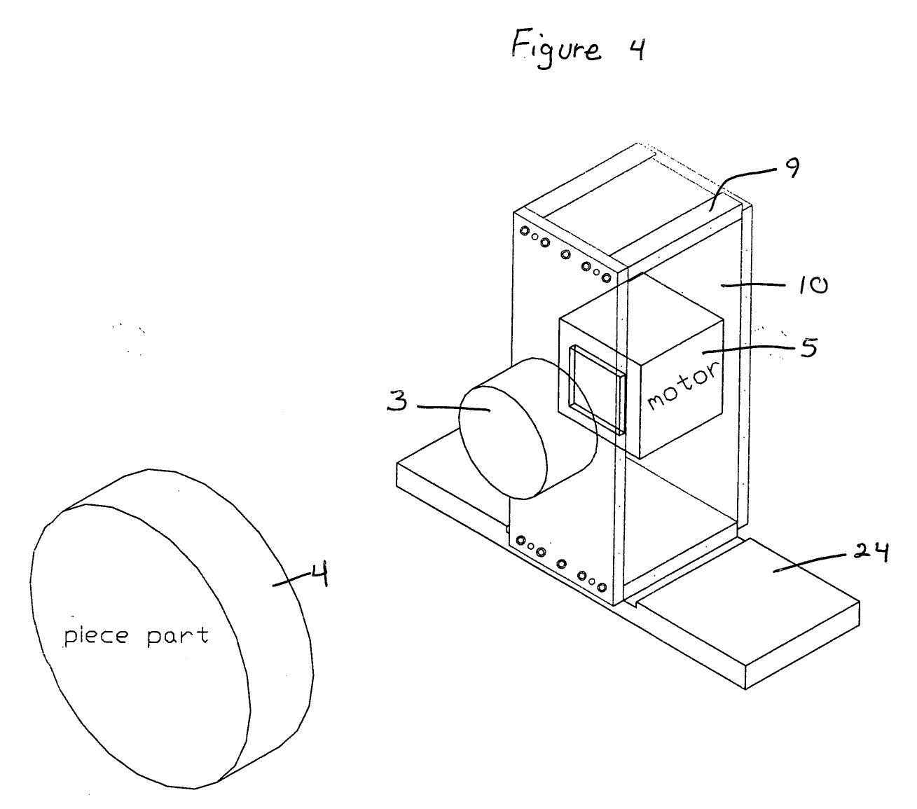

FIG. 4 shows cradle 10 removed from the assembly shown in FIG. 1. In this mode, cradle 10 functions as the prior art second positioning table and is attached to table 24. A tool can be mounted on a fixed end piece 22 as shown in FIG. 2.

1. A positioning table comprising
an assembly and a cradle wherein the assembly includes means to rotate the cradle wherein said means includes attachable elements that can be rotated about a first axis and capable of being attached to the sides of the cradle for rotating the cradle, wherein the cradle includes means for attaching to the attachable elements and where in said cradle has a work holder and means for rotating the work holder in an axis of rotation perpendicular to the first axis of rotation and wherein said cradle can be separated from the assembly by detaching from the attachable elements so that the separated assembly and separated cradle can operate as independent positioning tables.

2. A positioning table according to claim 1 wherein the attachable elements and the means to attach combine to form a sliding dovetail.

3. A positioning table according to claim 1 wherein the assembly includes an end piece that is not directly attached to the assembly that has an attachable element that can rotate about a first axis and capable of being attached to the to a side of the cradle

4. A positioning table according to claim 1 wherein the separated cradle comprises housing and a motor that rotates the work holder and wherein the motor is located within the housing.

5. A positioning table according to claim 4 which means to rotate does not include about an axis does not include the use of gears or gearboxes external to the housing of the rotational motors.

6. A positioning table according to claim 1 in combination with a CNC machine.

7. A CNC machine comprising a positioning table the separated assembly or the separated cradle of claim 1.

8. A kit comprising a positioning table having an assembly and a cradle wherein the assembly includes means to rotate the cradle wherein said means includes attachable elements that can be rotated about a first axis and capable of being attached to the sides of the cradle for rotating the cradle, wherein the cradle has means to attach to the attachable elements and where in said cradle has a work holder and means to rotate the work holder in an axis of rotation perpendicular to the first axis of rotation and wherein said cradle can be separated from the assembly so that the separated assembly and separated cradle can operate as independent positioning tables.

9. A kit according to claim 8 wherein said attachable elements includes an end piece that is not directly attached to the assembly that has an attachable element that can rotate about an axis and is capable of being attached to the to a side of the cradle.

10. A kit according to claim 8 which includes an end piece that is not directly attached to the assembly that has an attachable element capable of being attached to a work holder.

11. A kit according to claim 8 which includes an end piece capable of being used with the assembly or cradle.

12. A kit according to claim 8 which includes means to control the movement of the motors.

13. A positioning table according to claim 1 having means to control the movement of the motors.

14. A positioning table according to claim 1 wherein the means to rotate the cradle or means to rotate work piece by the cradle is a hydraulic or pneumatic power source.
